(19) United States
(12) Patent Application Publication
(10) Pub. No.: US 2026/0260400 A1
(43) Pub. Date: Sep. 3, 2026

(54) CHARACTER RENDERING METHOD, APPARATUS AND DEVICE

(71) Applicant: Beijing Zitiao Network Technology Co., Ltd., Beijing (CN)

(72) Inventors: Ruchong LUO, Beijing (CN); Hualong NING, Beijing (CN)

(21) Appl. No.: 19/553,014

(22) Filed: Feb. 27, 2026

(30) Foreign Application Priority Data
Feb. 28, 2025 (CN) 202510238045.0

(51) Int. Cl. G06T 11/23; G06T 11/40

(52) U.S. Cl. CPC G06T 11/23; G06T 11/40

(57) ABSTRACT

The present disclosure discloses a character rendering method, apparatus, and device. The method includes: in response to execution of a character image rendering task, acquiring rendering effect information of a character to be rendered in the character image rendering task, the rendering effect information being configured for indicating a first image element and a second image element; rendering the first image element for the character to be rendered at a first rendering level to obtain a first rendering result, and rendering the second image element for the character to be rendered at a second rendering level to obtain a second rendering result; and generating a rendered character image of the character to be rendered according to the first rendering result and the second rendering result, that is, obtaining an execution result of the character image rendering task.

### CROSS-REFERENCE TO RELATED APPLICATIONS

The present application claims the benefit of priority to the Chinese patent application No. 202510238045.0 filed with Chinese Patent Office on February 28, 2025, which is hereby incorporated by reference in its entirety into the present application.

### TECHNICAL FIELD

The present application relates to the technical field of media processing, and in particular, to a character rendering method, apparatus, and device.

### BACKGROUND

In many scenarios, media content edited by a user on a media editing client includes characters. On the media editing client, in order to obtain more personalized and pretty character image rendering effects, a character may be composed of a variety of constituent elements, which may include: an outline, a fill, a shadow, etc., and each constituent element may include a plurality of image elements, for example, the constituent element of an outline may include image elements such as an outline color, an outline width, and the like.

At present, in a media editing task, for a character including a variety of constituent elements, the various constituent elements of the character are stored together in data of several groups of meshes + materials, and when rendering the character including the variety of constituent elements, it is necessary to sequentially search for the various constituent elements of the character for each character, and then render the character according to all the various constituent elements of the character to obtain the rendering effect of the character, which is poor in flexibility and low in efficiency of character rendering.

### SUMMARY

In view of this, embodiments of the present application provide a character rendering method, an apparatus, and a device, which are capable of corresponding image elements of a character to be rendered to pre-divided rendering levels, and rendering each of the rendering levels separately, to complete rendering of a character image flexibly and efficiently, thereby improving efficiency and flexibility of the character image rendering.

To achieve the above objective, the technical solutions provided by the embodiments of the present application are as follows:

In a first aspect of the present application, a character rendering method is provided, including:

acquiring rendering effect information of a character to be rendered in a character image rendering task in response to execution of the character image rendering task, in which the rendering effect information is configured for indicating a first image element and a second image element;

rendering the first image element for the character to be rendered at a first rendering level to obtain a first rendering result, and rendering the second image element for the character to be rendered at a second rendering level to obtain a second rendering result; and

generating a rendered character image of the character to be rendered according to the first rendering result and the second rendering result.

In some implementations, the method further includes:

determining that the first image element belongs to the first rendering level and the second image element belongs to the second rendering level based on a preset mapping relationship.

As an example, a construction process of the preset mapping relationship includes:

associating a constituent element of a character image with a corresponding rendering level, wherein the constituent element is configured for indicating an element that constitutes a rendering effect of the character image; and

adding a layer tag to an image element included in each constituent element, wherein the layer tag is configured for indicating the rendering level to which the constituent element corresponding to the image element belongs, and the image element is configured for indicating a characteristic of the constituent element to which the image element belongs in a specific dimension.

As another example, for a newly added element, the method further includes:

determining whether the newly added element may be associated with an existing rendering level in the mapping relationship;

if yes, adding a layer tag of the existing rendering level corresponding to the newly added element to an image element included in the newly added element; and

if no, creating a newly added layer for the newly added element, and adding a layer tag corresponding to the newly added layer to the image element included in the newly added element.

In some implementations, the determining that the first image element belongs to the first rendering level and the second image element belongs to the second rendering level based on a preset mapping relationship includes:

acquiring a first layer tag of the first image element and a second layer tag of the second image element from the mapping relationship, wherein the first layer tag is configured for indicating the first rendering level, and the second layer tag is configured for indicating the second rendering level; and

determining that the first image element belongs to the first rendering level based on the first layer tag, and determining that the second image element belongs to the second rendering level based on the second layer tag.

In some implementations, the generating a rendered character image of the character to be rendered according to the first rendering result and the second rendering result includes:

processing the first rendering result and the second rendering result according to a preset level rendering sequence to generate the rendered character image.

In some implementations, the rendering effect information is further configured for indicating that a value of the first image element is a first value and a value of the second image element is a second value, and the rendering the first image element for the character to be rendered at a first rendering level to obtain a first rendering result, and rendering the second image element for the character to be rendered at a second rendering level to obtain a second rendering result includes:

rendering, at the first rendering level, the first image element for the character to be rendered based on the first value to obtain the first rendering result, and rendering, at the second rendering level, the second image element for the character to be rendered based on the second value to obtain the second rendering result.

In some implementations, the method further includes:

adding an update tag to the first rendering level to which the first image element belongs in response to an update operation for the value of the first image element of the character to be rendered; and

updating the value of the first image element based on the update tag,

the rendering the first image element for the character to be rendered at a first rendering level to obtain a first rendering result includes:

rendering, at the first rendering level, the first image element for the character to be rendered with the updated value of the first image element to obtain the first rendering result.

In some implementations, the image element indicated by the rendering effect information corresponds to at least two of the following rendering levels: a canvas layer, a background layer, a text selection box layer, a shadow layer, an outlines layer, an emoji layer, a fill layer, an inner shadow layer, a bloom layer, or a global blend layer.

In some implementations, the image element includes a color and/or a size of a corresponding constituent element.

In a second aspect of the present application, a character rendering apparatus is further provided, including:

an acquiring unit, configured to acquire rendering effect information of a character to be rendered in a character image rendering task in response to execution of the character image rendering task, wherein the rendering effect information is configured for indicating a first image element and a second image element;

a rendering unit, configured to render the first image element for the character to be rendered at a first rendering level to obtain a first rendering result, and render the second image element for the character to be rendered at a second rendering level to obtain a second rendering result; and

a generating unit, configured to generate a rendered character image of the character to be rendered according to the first rendering result and the second rendering result.

In some implementations, the apparatus further includes:

a determining unit, configured to determine that the first image element belongs to the first rendering level and the second image element belongs to the second rendering level based on a preset mapping relationship.

As an example, the apparatus further includes: a constructing unit, configured to construct the preset mapping relationship. The constructing unit is specifically configured to:

associate a constituent element of a character image with a corresponding rendering level, wherein the constituent element is configured for indicating an element that constitutes a rendering effect of the character image; and

add a layer tag to an image element included in each constituent element, wherein the layer tag is configured for indicating the rendering level to which the constituent element corresponding to the image element belongs, and the image element is configured for indicating a characteristic of the constituent element to which the image element belongs in a specific dimension.

As another example, for a newly added constituent element, the apparatus further includes:

a layer tag adding unit, configured to determine whether the newly added constituent element may be associated with an existing rendering level in the mapping relationship;

if yes, add a layer tag of the existing rendering level corresponding to the newly added constituent element to an image element included in the newly added constituent element; and

if no, create a newly added layer for the newly added constituent element, and add a layer tag corresponding to the newly added layer to the image element included in the newly added constituent element.

In some implementations, the determining unit is specifically configured to:

acquire a first layer tag of the first image element and a second layer tag of the second image element from the mapping relationship, wherein the first layer tag is configured for indicating the first rendering level, and the second layer tag is configured for indicating the second rendering level; and

determine that the first image element belongs to the first rendering level based on the first layer tag, and determine that the second image element belongs to the second rendering level based on the second layer tag.

In some implementations, the generating unit is specifically configured to:

process the first rendering result and the second rendering result according to a preset level rendering sequence to generate the rendered character image.

In some implementations, the rendering effect information is further configured for indicating that a value of the first image element is a first value and a value of the second image element is a second value, and the rendering unit is specifically configured to:

render, at the first rendering level, the first image element of the character to be rendered based on the first value to obtain the first rendering result, and render, at the second rendering level, the second image element of the character to be rendered based on the second value to obtain the second rendering result.

In some implementations, the apparatus further includes:

an updating unit, configured to add an update tag to the first rendering level to which the first image element belongs in response to an update operation for the value of the first image element of the character to be rendered;

the updating unit is further configured to update the value of the first image element based on the update tag; and

the rendering unit is specifically configured to:

render, at the first rendering level, the first image element for the file to be rendered with the updated value of the first image element to obtain the first rendering result.

In some implementations, the image element indicated by the rendering effect information corresponds to at least two of the following rendering levels: a canvas layer, a background layer, a text selection box layer, a shadow layer, an outlines layer, an emoji layer, a fill layer, an inner shadow layer, a bloom layer, or a global blend layer.

In some implementations, the image element includes a color and/or a size of a corresponding constituent element.

It should be noted that for the specific implementation of the apparatus and the technical effect achieved, reference may be made to the relevant description of the method provided in the first aspect or any implementation of the first aspect.

In a third aspect of the present application, an electronic device is provided, and the electronic device includes: a processor and a memory, the memory is configured to store instructions or a computer program, and the processor is configured to execute the instructions or the computer program in the memory to cause the electronic device to perform the method provided in the first aspect or any implementation of the first aspect.

In a fourth aspect of the present application, a computer-readable storage medium is provided, wherein instructions are stored in the computer-readable storage medium, and the instructions, when run on a processor, cause the processor to perform the method provided in the first aspect or any implementation of the first aspect.

In a fifth aspect of the present application, a computer program product is provided, and the computer program product includes a computer program or instructions, and the method provided in the first aspect or any implementation of the first aspect is implemented when the computer program or the instructions are executed by a processor.

It may be seen that the present application has the following beneficial effects:

In the present application, a character rendering method is provided, and the method, for example, may include: acquiring rendering effect information of a character to be rendered in a character image rendering task in response to execution of the character image rendering task, wherein the rendering effect information is configured for indicating a first image element and a second image element; then, rendering the first image element for the character to be rendered at a first rendering level to obtain a first rendering result, and rendering the second image element for the character to be rendered at a second rendering level to obtain a second rendering result; and thus, generating a rendered character image of the character to be rendered according to the first rendering result and the second rendering result, that is, obtaining an execution result of the character image rendering task.

### BRIEF DESCRIPTION OF THE DRAWINGS

In order to more clearly illustrate the technical solutions in the embodiments of the present application or in the related art, the following briefly introduces the drawings that need to be used in the description of the embodiments or the related art. Obviously, the drawings in the following description are only some embodiments of the present application, and for those of ordinary skill in the art, other drawings may also be obtained according to these drawings without creative labor.

FIG. 1 is a schematic diagram of a character rendering effect provided by an embodiment of the present application;

FIG. 2 is a schematic diagram of storage of data involved in current character rendering;

FIG. 3 is a schematic flowchart of a character rendering method provided by an embodiment of the present application;

FIG. 4 is a schematic diagram of hierarchical storage of data involved in character rendering provided by an embodiment of the present application;

FIG. 5 is a schematic structural diagram of a character rendering apparatus 500 provided by an embodiment of the present application; and

FIG. 6 is a schematic structural diagram of an electronic device 600 provided by an embodiment of the present application.

### DETAILED DESCRIPTION OF EMBODIMENTS

In order to enable those skilled in the art to better understand the solutions of the present application, the technical solutions in the embodiments of the present application will be described clearly and completely below in combination with the drawings in the embodiments of the present application. Obviously, the described embodiments are only a part of the embodiments of the present application, rather than all of them. All other embodiments obtained by those of ordinary skill in the art based on the embodiments in the present application without creative efforts shall fall within the protection scope of the present application.

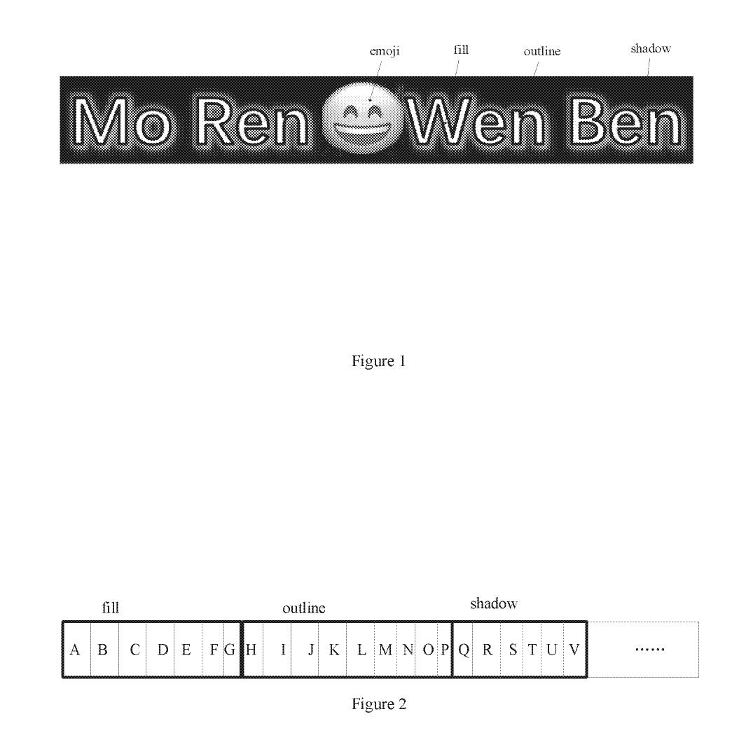

In a media editing client, media content edited by a user may include a text, and for a higher-quality and richer display effect, a character image in the text usually includes a variety of constituent elements. The constituent element may refer to a drawing element when the character is displayed, and the constituent elements of the character may include, for example: an outline, a fill, a shadow, and the like. Each constituent element includes at least one image element, and the image element is used for indicating a characteristic of the corresponding constituent element in a certain dimension, for example, the constituent element of an outline may include image elements such as an outline color, an outline width, and the like. As shown in FIG. 1, the displayed text includes 5 characters, which are four text characters of "mo", "ren", "wen", "ben", and one expression character. The constituent elements included in the four character characters of "mo", "ren", "wen", "ben" are: an outline, a fill, and a shadow, the outline elements of the four character characters may include two image elements of an outline color and an outline width, and a value of the outline color is red; the fill elements of the four text characters may include an image element of a fill color, and a value of the fill color is white. It should be noted that the constituent elements of the expression character are different from those of the text character, so the constituent elements of the expression character may be understood as being composed of special constituent elements, which may be called "expression (which may also be called Emoji)".

At present, reference may be made to FIG. 2 for a storage manner of the media content corresponding to the text to be rendered. Usually, the storage space is divided into different areas according to constituent elements, each area stores data corresponding to one constituent element, each area is further divided into different sub-areas according to different characters, and each sub-area stores rendering data of one element on one character. As shown in FIG. 2, the storage area sequentially includes: an area corresponding to a fill element, an area corresponding to an outline element, and an area corresponding to a shadow element; the area corresponding to the fill element includes: 7 sub-areas A, B, ..., G in total, and each sub-area may correspond to one text character; the area corresponding to the outline element includes: 9 sub-areas H, I, ..., P in total, and the area corresponding to the shadow element includes: 6 sub-areas Q, R, ..., V in total. It should be noted that the number of constituent elements and specific constituent elements included in each text character may be the same or different. Assuming that the rendering data corresponding to the text character "mo" includes D, K, and S, and the rendering data corresponding to the character "ren" includes E, M, and V, when executing the character rendering task corresponding to FIG. 1, a rendering process 1 of "mo" and a rendering process 2 of "ren" are included. The rendering process 1 is executed first, specifically, D, K, and S need to be searched for from the array shown in FIG. 2 first, and then "mo" in the picture shown in FIG. 1 is obtained by performing rendering based on D, K, and S; then the rendering process 2 is executed, specifically, E, M, and V need to be searched for from the array shown in FIG. 2 first, and then "ren" in the picture shown in FIG. 1 is obtained by performing rendering based on E, M, and V. It may be seen that the current character rendering method needs to render character one by one, and the data required for rendering is stored in a relatively large array, and when rendering each character, the corresponding constituent elements need to be searched for from the array, which causes a relatively large time loss. That is to say, in the current character rendering manner, because the rendering data required for the character is stored together, the internal coupling is relatively high, the code structure is huge and complex, and all constituent elements need to be combined and drawn together during rendering, which makes it difficult to independently separate image elements, and it is also difficult to perform operations such as drawing and updating of local effects, and the flexibility is relatively poor.

Based on this, an embodiment of the present application provides a character rendering method, which, for example, may include: acquiring rendering effect information of a character to be rendered in a character image rendering task in response to execution of the character image rendering task, wherein the rendering effect information is used for indicating a first image element and a second image element; then, rendering the first image element for the character to be rendered at a first rendering level to obtain a first rendering result, and rendering the second image element for the character to be rendered at a second rendering level to obtain a second rendering result; and thus, generating a rendered character image of the character to be rendered according to the first rendering result and the second rendering result, that is, obtaining an execution result of the character image rendering task.

It may be seen that, with the method, for the character to be rendered in the character image rendering task, image elements of the character to be rendered may be acquired, and a plurality of image elements may be separately rendered at corresponding rendering levels according to the rendering level to which the image element belongs, and then a rendered file image corresponding to the character to be rendered may be generated based on rendering results at different rendering levels, without the need to render the character to be rendered in the character image rendering task character by character (that is, for each character, sequentially search for various constituent elements of the character, and then render the character according to all the various constituent elements of the character to obtain the rendering effect of the character), thereby overcoming the current problems of poor flexibility and low efficiency of character rendering, and through a level rendering strategy, the image elements of the character to be rendered are independently corresponding to the rendering levels, thereby improving the flexibility of character rendering, and reducing the time loss of character rendering, and improving the efficiency of character rendering.

It should be noted that the subject for implementing the character rendering method may be a character rendering apparatus provided by an embodiment of the present application. The character rendering apparatus may be carried in an electronic device or a functional module of the electronic device. The character rendering apparatus, for example, may be a functional module on a network device such as a server or a terminal device such as a mobile phone configured to implement the character rendering function provided by the embodiment of the present application, for example, may be a module on a media editing client on the terminal device configured to implement the character rendering function.

Before introducing the method provided by the embodiment of the present application, the basic concepts involved will be briefly introduced first.

A layer may refer to a unit that is determined according to possible constituent elements of a character and is used for carrying data required for rendering the character. The possible constituent elements of the character may include the constituent elements that the character currently has and the constituent elements that may exist in the future. The layer may be flexibly designed and divided according to requirements. A reasonable division granularity may provide convenience for character rendering and overall editing of the media content, that is, the division granularity of the layer cannot be too small, as this will increase the subsequent maintenance cost; the division granularity of the layer cannot be too large, as this will affect the iteration of subsequent functions (such as local effects). As an example, in the embodiment of the present application, the layer may include: a canvas layer, a background layer, a text selection box layer, a shadow layer, an outlines layer, an emoji layer, a fill layer, an inner shadow layer, a bloom layer, or a global blend layer, and in one character image rendering task, image elements in at least one character to be rendered may correspond to at least two of the above layers, and the number of layers corresponding to image elements in other characters to be rendered may not be limited.

The constituent element may refer to a drawing element when the character is displayed, and the constituent elements of the character may include, for example: an outline, a fill, a shadow, and the like.

The image element is used for indicating a characteristic of the corresponding constituent element in a certain dimension, and each constituent element includes at least one image element. For example, the image element may include a color and/or a size of the corresponding constituent element. For the constituent element of an outline, the image elements may include an outline color, an outline width, and the like; for the constituent element of a fill, the image elements may include a fill color, a fill width, and the like; for the constituent element of a canvas, the image elements may include a canvas color, a canvas width, a canvas height, and the like.

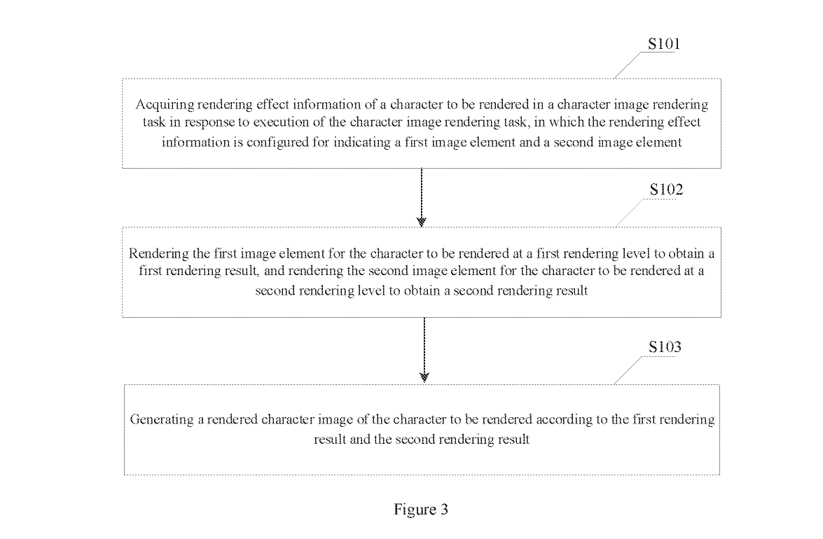

FIG. 3 is a schematic flowchart of a character rendering method provided by an embodiment of the present application. The method may be applied to a character rendering apparatus, and the character rendering apparatus, for example, may be a character rendering apparatus 500 shown in FIG. 5 below.

As shown in FIG. 3, the method, for example, may include the following S101 to S103:

S101, acquiring rendering effect information of a character to be rendered in a character image rendering task in response to execution of the character image rendering task, wherein the rendering effect information is used for indicating a first image element and a second image element.

It may be understood that when the user edits media content on the media editing client, if the media content includes a character, a corresponding character image rendering task will inevitably be generated after the style editing of the character is completed, and the purpose of executing the character image rendering task is to display the corresponding rendering effect for the edited character, which may meet the user's requirements when editing the style of the character.

The execution of the character image rendering task may be triggered by a corresponding execution operation. The execution operation may be any operation that the user triggers on the media editing client to execute the character image rendering task, and the execution operation is used for triggering the character rendering apparatus to start rendering the character whose rendering is instructed in the character image rendering task. The character image rendering task may include: at least one character to be rendered, and image elements and their values of each character to be rendered. The image elements and their values of each character to be rendered may be data generated when the user performs an editing operation on the character to be rendered, for example, when the user edits the media content, the editing operation includes: instructing to display "mo ren", and instructing that the image elements and their values of "mo" include: a fill color of white, a fill width of a, an outline color of red, an outline width of b, a shadow color of white, and a shadow width of c; instructing that the image elements and their values of "ren" include: a fill color of white, a fill width of a, an outline color of black, and an outline width of d. Then, based on S101, it may be obtained that the image elements of the character to be rendered "mo" include a fill color, a fill width, an outline color, an outline width, a shadow color, and a shadow width, and it may be obtained that the image elements of the character to be rendered "ren" include a fill color, a fill width, an outline color, and an outline width.

The rendering effect information may include at least one character to be rendered, and image elements and their values of each character to be rendered. In the embodiment of the present application, one file to be rendered is taken as an example for description, and the character to be rendered includes two image elements, and the character to be rendered may also include more image elements, and the implementation method is similar to that in FIG. 3.

S102, rendering the first image element for the character to be rendered at a first rendering level to obtain a first rendering result, and rendering the second image element for the character to be rendered at a second rendering level to obtain a second rendering result.

S103, generating a rendered character image of the character to be rendered according to the first rendering result and the second rendering result.

Before S102, the method may further include a process of constructing a mapping relationship. The process, for example, may include: S11, associating constituent elements of a character with corresponding rendering levels, wherein the constituent elements are used for indicating elements that constitute a rendering effect of the character; and S12, adding a layer tag to image elements included in each constituent element, in which the layer tag is used for indicating the rendering level to which the constituent element corresponding to the image element belongs, and the image element is used for indicating a characteristic of the constituent element to which the image element belongs in a specific dimension.

It may be understood that the constituent elements of the character in S11 may refer to constituent elements that are as comprehensive as possible, and the constituent elements currently used in character editing and the constituent elements not currently used in character editing but may be used in character editing in the future are all "associated" to the corresponding rendering levels through S11, which is equivalent to creating rendering levels that are as reasonable as possible based on the constituent elements. For example, the constituent elements of the character include an outline, a fill, and a shadow, then, through S11, the constituent element of the outline is associated with the outline layer, which is equivalent to creating the outline layer, and the outline layer includes the constituent element of the outline; similarly, through S11, the constituent element of the fill is associated with the fill layer, which is equivalent to creating the fill layer, and the fill layer includes the constituent element of the fill; through S11, the constituent element of the shadow is associated with the shadow layer, which is equivalent to creating the shadow layer, and the shadow layer includes the constituent element of the shadow. It should be noted that each rendering level may include at least one constituent element.

In order to enable the image elements in the character image rendering task to directly correspond to the rendering levels during rendering, and improve rendering efficiency, data reconstruction may also be performed after S11, that is, the image elements included in the constituent element in each rendering level are corresponded to the rendering level to which the constituent element belongs. As an example, this correspondence may be achieved through S12, that is, by adding a layer tag to the image elements. For example, for the constituent element of a canvas, which includes image elements such as a canvas color, a canvas width, a canvas height, and the like. Through S12, the layer tag of "canvas layer" is added to the image elements such as the canvas color, the canvas width, the canvas height, and the like, to achieve the association between the image elements and the rendering level, and in actual character rendering, it is no longer necessary to determine the constituent element to which the image elements such as the canvas color and the canvas width and height belong, and then determine the rendering level based on the constituent element, and then perform rendering based on the rendering level, but the image elements such as the canvas color and the canvas width and height may be directly determined to belong to the canvas layer, so as to render the canvas layer, which saves rendering time; for another example, for the constituent element of an outline, which includes image elements such as an outline color, an outline width (which may also be called an outline thickness), and the like. Through S12, the layer tag of "outline layer" is added to the image elements such as the outline color and the outline width, to achieve the association between the image elements and the rendering level.

The mapping relationship is constructed to provide a basis for executing the method, which makes it possible to achieve fast and flexible character rendering based on the method.

In some possible implementations, the data storage manner provided by the method may conveniently add or delete the corresponding rendering level.

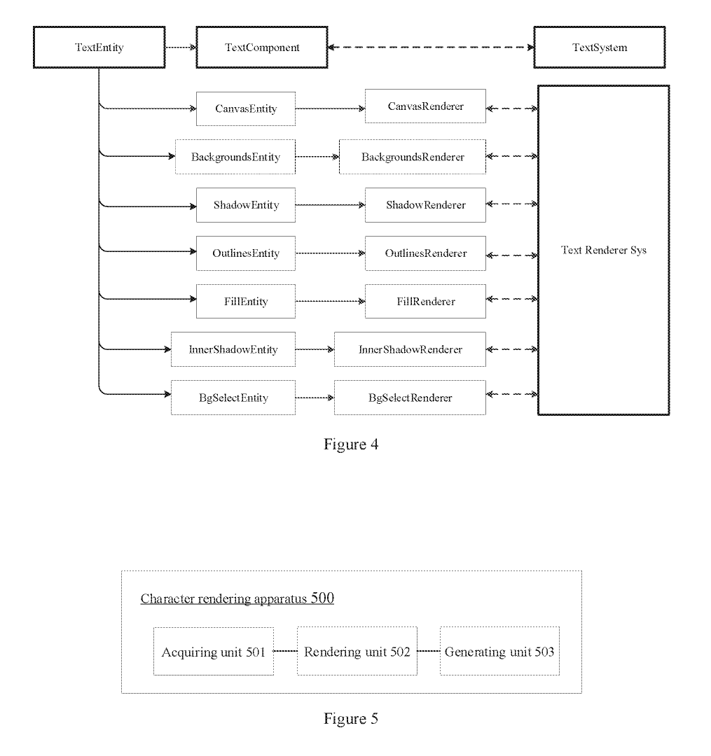

For example, a newly added element suitable for character editing appears on the media editing client, then the method may further include: S21, determining whether the newly added element may be associated with an existing rendering level in the mapping relationship, if yes, executing S22, if no, executing S23; S22, adding a layer tag of the existing rendering level corresponding to the newly added element to an image element included in the newly added element; and S23, creating a newly added layer for the newly added element, and adding a layer tag corresponding to the newly added layer to the image elements included in the newly added element. As shown in FIG. 4, the background layer in the dotted box may be a rendering level created for the newly added element, which is very flexible and convenient.

For another example, an element to be deleted for character editing on the media editing client can no longer be used and needs to be invalidated, then, the method may further include: eliminating the element to be deleted from the rendering level to which the element to be deleted belongs. It should be noted that if the rendering level to which the element to be deleted belongs includes only the element to be deleted, the rendering level in which the element to be deleted is located may be directly deleted. As shown in FIG. 4, each created rendering level or part of elements in the rendering level may be deleted according to actual needs, which is very flexible and convenient.

On the basis of constructing the mapping relationship, before S102, the method may further include: determining that the first image element belongs to the first rendering level and the second image element belongs to the second rendering level according to the preset mapping relationship, wherein the mapping relationship is used for indicating a correspondence between rendering levels and image elements. In this way, after S101, the rendering level to which each image element belongs may be determined based on the acquired image elements of the character to be rendered, so as to prepare for level character rendering.

As an example, if the association between the rendering levels and the image elements in the preset mapping relationship is achieved by adding a corresponding layer tag to the image elements, the "determining that the first image element belongs to the first rendering level according to the preset mapping relationship" may include: acquiring a first layer tag of the first image element from the mapping relationship, in which the first layer tag is used for indicating the first rendering level; and determining that the first image element belongs to the first rendering level based on the first layer tag. Similarly, the "determining that the second image element belongs to the second rendering level according to the preset mapping relationship" may include: acquiring a second layer tag of the second image element from the mapping relationship, in which the second layer tag is used for indicating the second rendering level; and determining that the second image element belongs to the second rendering level based on the second layer tag.

It should be noted that only two image elements included at least in the character to be rendered in the character image rendering task are taken as an example for description, and actually, the rendering level to which each image element of each character to be rendered belongs may be determined according to the mapping relationship.

Taking the character to be rendered including "mo" in the above example as an example, it is determined based on the mapping relationship that the fill color and the fill width have a "fill layer" tag and belong to the fill layer; similarly, it is determined based on the mapping relationship that the outline color and the outline width have an "outline layer" tag and belong to the outline layer; it is determined based on the mapping relationship that the shadow color and the shadow width have a "shadow layer" tag and belong to the shadow layer.

In some implementations, S102 to S103 may include: for the file to be rendered including the first image element and the second image element, rendering is performed according to the preset level rendering sequence, and the rendering effect of the character to be rendered is displayed. The level rendering sequence is a preset sequence of rendering at each layer during character rendering, which may be flexibly designed according to actual needs.

As an example, the character image rendering task may include values corresponding to the image elements of the character to be rendered, and the character to be rendered including the first image element belonging to the first rendering level and the second image element belonging to the second rendering level is rendered according to the preset level rendering sequence, for example, the rendering may includes: according to the level rendering sequence, in the first rendering level, rendering is performed with a first value corresponding to the first image element to obtain the first rendering result, and in the second rendering level, rendering is performed with a second value corresponding to the second image element to obtain the second rendering result; and thus, the final rendered character image is generated based on the first rendering result and the second rendering result.

For example, the level rendering sequence may instruct to render the fill layer first, then the outline layer, and then the shadow layer. For "mo" in the above example, the fill layer of "mo" may be rendered first based on "the fill color is white and the fill width is a"; then the outline layer of "mo" is rendered based on "the outline color is red and the outline width is b"; and then the shadow layer of "mo" is rendered based on "the shadow color is white and the shadow width is c".

It should be noted that in the embodiment of the present application, the plurality of characters to be rendered in the character image rendering task may be batch-rendered, that is, the plurality of characters to be rendered are rendered layer by layer according to the level rendering sequence. For example, the character image rendering task includes 100 characters to be rendered, and the level rendering sequence instructs to render the first rendering level first, then the second rendering level, and then the third rendering level, then the process of S102 to S103 may include: first rendering the first rendering level for several characters to be rendered with image elements belonging to the first rendering level in the plurality of characters to be rendered; then rendering the second rendering level for several characters to be rendered with image elements belonging to the second rendering level in the plurality of characters to be rendered; and then rendering the third rendering level for several characters to be rendered with image elements belonging to the third rendering level in the plurality of characters to be rendered, and so on. It should be noted that if the image elements of the plurality of characters to be rendered are the same, S102 to S103 may include: for the plurality of characters to be rendered, first rendering the first rendering level, then rendering the second rendering level, and then rendering the third rendering level. Compared with the current character rendering manner, such a manner of batch-rendering characters layer by layer greatly improves the efficiency of character rendering and reduces the time loss of character-by-character rendering.

Taking the schematic diagram of the hierarchical storage of data involved in character rendering shown in FIG. 4 as an example, in the embodiment of the present application, the part related to character rendering in the media editing client may include: a text entity (TextEntity), a text component (TextComponent), and a text system (TextSystem), in which entities corresponding to various layers may be created under the text entity, and the entities corresponding to each layer may be understood as a plurality of nodes under a root entity in a tree-shaped storage structure. The layer entity corresponding to the dotted box may indicate a newly added or layer entity to be deleted, which is used to illustrate that the storage structure is convenient for expansion and adjustment. In the embodiment of the present application, a corresponding renderer is set for each layer entity, each layer entity is rendered hierarchically by the corresponding renderer, and the obtained result is finally rendered by the text rendering system to obtain the displayed rendering result.

In some possible implementations, the method may achieve separate data updating through independent control permission of each rendering level. For example, for the embodiment shown in FIG. 3 above, the method further includes: determining that the first image element belongs to the first rendering level according to the mapping relationship in response to an update operation for a value of the first image element of the character to be rendered; adding an update tag to the first rendering level; and updating the value of the first image element based on the update tag. Therefore, for S102, for example, it may include: rendering the first rendering level with the updated value of the first image element. In this way, flexible control of text editing and rendering may be achieved. It may be understood that in the current character rendering manner, if an image element needs to be adjusted, all data of the character to be rendered needs to be updated, which consumes a relatively large amount of resources and other costs, and is very inconvenient, but based on the method provided by the embodiment of the present application, if an image element needs to be adjusted, only the data in the rendering level associated with the image element needs to be updated, and the data in other rendering levels may not be affected For example, the first image element is an outline color, then, based on this embodiment, an update tag needs to be added only to the outline layer associated with the outline color, and only the data of the outline layer may be updated, specifically, the outline color in the outline layer is updated, which is very convenient. The update tag may also be called a "dirty tag", and for the rendering level marked with the "dirty tag", before rendering, it may be determined whether the data at each rendering level needs to be updated, that is, whether the data at each rendering level is "dirty". The determination basis is whether there is a "dirty tag". If there is, the data at the rendering level is considered to be "dirty" and thus updated; if not, the data is not updated.

It may be seen that, with the method, for the character to be rendered in the character image rendering task, image elements of the character to be rendered may be acquired, and a plurality of image elements may be separately rendered at corresponding rendering levels according to the rendering levels to which the image elements belong, and then a rendered file image corresponding to the character to be rendered may be generated based on rendering results at different rendering levels, without the need to render the characters to be rendered in the character image rendering task character by character (that is, for each character, sequentially search for various constituent elements of the character, and then render the character according to all the various constituent elements of the character to obtain the rendering effect of the character), thereby overcoming the current problems of poor flexibility and low efficiency of character rendering. Through a level rendering strategy, the image elements of the character to be rendered are independently corresponding to the rendering levels, thereby improving the flexibility of character rendering, and reducing the time loss of character rendering, and improving the efficiency of character rendering.

Correspondingly, an embodiment of the present application further provides a character rendering apparatus 500, as shown in FIG. 5. The apparatus 500 may include:

an acquiring unit 501, configured to acquire rendering effect information of a character to be rendered in a character image rendering task in response to execution of the character image rendering task, wherein the rendering effect information is used for indicating a first image element and a second image element;

a rendering unit 502, configured to render the first image element for the character to be rendered at a first rendering level to obtain a first rendering result, and render the second image element for the character to be rendered at a second rendering level to obtain a second rendering result; and

a generating unit 503, configured to generate a rendered character image of the character to be rendered according to the first rendering result and the second rendering result.

In some implementations, the apparatus 500 further includes:

a determining unit, configured to determine that the first image element belongs to the first rendering level and the second image element belongs to the second rendering level based on a preset mapping relationship.

As an example, the apparatus 500 further includes: a constructing unit, configured to construct the preset mapping relationship. The constructing unit is further configured to:

associate a constituent element of a character image with a corresponding rendering level, wherein the constituent element is used for indicating an element that constitutes a rendering effect of the character image; and

add a layer tag to image elements included in each constituent element, wherein the layer tag is used for indicating the rendering level to which the constituent element corresponding to the image element belongs, and the image element is used for indicating a characteristic of the constituent element to which the image element belongs in a specific dimension.

As another example, for a newly added element, the apparatus 500 further includes:

a layer tag adding unit, configured to determine whether the newly added element may be associated with an existing rendering level in the mapping relationship;

if yes, add a layer tag of the existing rendering level corresponding to the newly added element to image elements included in the newly added element; and

if no, create a newly added layer for the newly added element, and add a layer tag corresponding to the newly added layer to the image elements included in the newly added element.

In some implementations, the determining unit is further configured to:

acquire a first layer tag of the first image element and a second layer tag of the second image element from the mapping relationship, wherein the first layer tag is used for indicating the first rendering level, and the second layer tag is used for indicating the second rendering level; and

determine that the first image element belongs to the first rendering level based on the first layer tag, and determine that the second image element belongs to the second rendering level based on the second layer tag.

In some implementations, the generating unit 503 is specifically configured to:

process the first rendering result and the second rendering result according to a preset level rendering sequence to generate the rendered character image.

In some implementations, the rendering effect information is further used for indicating that a value of the first image element is a first value and a value of the second image element is a second value, and the rendering unit 502 is specifically configured to:

render, at the first rendering level, the character to be rendered for the first image element being the first value to obtain the first rendering result, and render, at the second rendering level, the character to be rendered for the second image element being the second value to obtain the second rendering result.

In some implementations, the apparatus 500 further includes:

an updating unit, configured to add an update tag to the first rendering level to which the first image element belongs in response to an update operation for the value of the first image element of the character to be rendered;

the updating unit is further configured to update the value of the first image element based on the update tag; and

the rendering unit 502 is specifically configured to:

render, at the first rendering level, the file to be rendered with the updated value of the first image element to obtain the first rendering result.

In some implementations, the image element indicated by the rendering effect information corresponds to at least two of the following rendering levels: a canvas layer, a background layer, a text selection box layer, a shadow layer, an outline layer, an emoji layer, a fill layer, an inner shadow layer, a bloom layer, or a global blend layer.

In some implementations, the image element includes a color and/or a size of a corresponding constituent element.

It should be noted that for the specific implementation of the apparatus 500 and the technical effect achieved, reference may be made to the relevant description of the method shown in the embodiment of the present application.

In addition, an embodiment of the present application further provides an electronic device, and the electronic device includes a processor and a memory, the memory is configured to store instructions or a computer program, and the processor is configured to execute the instructions or the computer program in the memory to cause the electronic device to perform any implementation of the method provided by the embodiment of the present application.

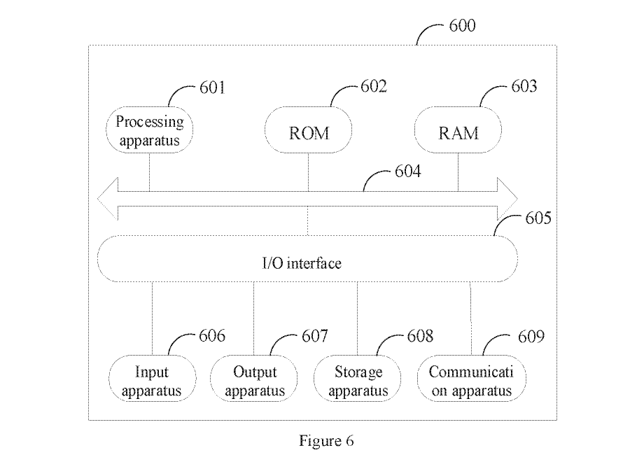

Referring to FIG. 6, it shows a schematic structural diagram of an electronic device 600 suitable for implementing an embodiment of the present disclosure. The terminal device in the embodiment of the present disclosure may include, but is not limited to, mobile terminals such as a mobile phone, a notebook computer, a digital broadcast receiver, a personal digital assistant (PDA), Portable Android Device (PAD), a portable media player (PMP), a vehicle-mounted terminal (e.g., a vehicle navigation terminal), etc., and fixed terminals such as a digital TV, a desktop computer, etc. The electronic device shown in FIG. 6 is only an example, and should not bring any limitation to the function and scope of use of the embodiment of the present disclosure.

As shown in FIG. 6, the electronic device 600 may include a processing apparatus (such as a central processing unit, a graphics processor, etc.) 601, which may perform various appropriate actions and processing according to a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Usually, the following apparatus may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 with various apparatuses, it should be understood that it is not required to implement or have all of the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, and the computer program contains program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiment of the present disclosure are executed.

The electronic device provided by the embodiment of the present disclosure belongs to the same inventive concept as the method provided by the above-mentioned embodiments, and for technical details not described in detail in this embodiment, reference may be made to the above-mentioned embodiments, and this embodiment has the same beneficial effects as the above-mentioned embodiments.

An embodiment of the present application further provides a computer-readable medium, in which instructions or a computer program is stored in the computer-readable medium, and the instructions or the computer program, when running on a device, causes the device to perform any implementation of the method provided by the embodiment of the present application.

It should be noted that the above-mentioned computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program code is carried therein. This propagated data signal may adopt multiple forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program for use by or in combination with the instruction execution system, apparatus, or device. The program code contained on the computer-readable medium may be transmitted by any suitable medium, including but not limited to: a wire, an optical cable, a radio frequency (RF), etc., or any suitable combination of the above.

The above-mentioned computer-readable medium may be included in the above-mentioned electronic device, or may exist alone without being assembled into the electronic device.

The above-mentioned computer-readable medium carries one or more programs, and when the one or more programs are executed by the electronic device, the electronic device is caused to execute the above-mentioned method.

The computer program code for performing the operations of the present disclosure may be written in one or more programming languages or a combination thereof, and the above-mentioned programming languages include, but are not limited to, an object-oriented programming language, such as Java, Smalltalk, C++, and also include conventional procedural programming languages, such as "C" language or similar programming languages. The program code may be executed entirely on a user's computer, partly executed on a user's computer, executed as an independent software package, partly executed on a user's computer and partly executed on a remote computer, or entirely executed on a remote computer or server. In the case of involving a remote computer, the remote computer may be connected to a user's computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or hardware. The name of a unit/module does not constitute a limitation on the unit itself under certain circumstances.

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that the various embodiments in this specification are described in a progressive manner, and each embodiment focuses on the differences from other embodiments, and the same and similar parts between the various embodiments may be referred to each other. For the system or apparatus disclosed in the embodiments, since it corresponds to the method disclosed in the embodiments, the description is relatively simple, and for the relevant parts, reference may be made to the description of the method part.

It should be understood that in the present application, "at least one (item)" means one or more, and "a plurality of" means two or more. "And/or" is used to describe an association relationship between associated objects, and represents that three relationships may exist, for example, "A and/or B" may represent: only A exists, only B exists, and both A and B exist, where A and B may be singular or plural. The character "/" generally indicates that the associated objects before and after “/” are in an "or" relationship. "At least one of the following items (pieces)" or a similar expression thereof refers to any combination of these items, including a single item (piece) or any combination of plural items (pieces). For example, at least one of a, b, or c may represent: a, b, c, "a and b", "a and c", "b and c", or "a and b and c", where a, b, and c may be single or multiple.

It should also be noted that in this paper, relational terms such as first and second are only used to distinguish one entity or operation from another entity or operation, and do not necessarily require or imply any actual relationship or order between these entities or operations. Moreover, the terms "include", "includes", or any other variant thereof are intended to cover non-exclusive inclusion, so that a process, method, object, or device including a series of elements includes not only those elements, but also other elements not explicitly listed or elements inherent to such process, method, object, or device. Without further restrictions, an element defined by the phrase "including a" does not exclude that there are other identical elements in the process, method, object, or device including the element.

The steps of the method or algorithm described in combination with the embodiments disclosed herein may be directly implemented by hardware, a software module executed by a processor, or a combination thereof. The software module may be placed in a random access memory (RAM), an internal memory, a read-only memory (ROM), an electrically programmable ROM, an electrically erasable programmable ROM, a register, a hard disk, a removable magnetic disk, a CD-ROM, or any other form of storage medium known in the technical field.

It should be noted that the embodiments of the present application do not involve sensitive information of the user, and even if the user's related information is used, the user's related information is acquired, used, and determined after being authorized by the user.

The above description of the disclosed embodiments enables those skilled in the art to implement or use the present application. Various modifications to these embodiments will be obvious to those skilled in the art, and the general principles defined herein may be implemented in other embodiments without departing from the spirit or scope of the present application. Therefore, the present application will not be limited to the embodiments shown herein, but is to be accorded the widest scope consistent with the principles and novel features disclosed herein.

What is claimed is:

1. A character rendering method, comprising:
acquiring rendering effect information of a character to be rendered in a character image rendering task in response to execution of the character image rendering task, wherein the rendering effect information is configured for indicating a first image element and a second image element;
rendering the first image element for the character to be rendered at a first rendering level to obtain a first rendering result, and rendering the second image element for the character to be rendered at a second rendering level to obtain a second rendering result; and
generating a rendered character image of the character to be rendered according to the first rendering result and the second rendering result.

2. The method of claim 1, wherein the method further comprises:
determining that the first image element belongs to the first rendering level and the second image element belongs to the second rendering level based on a preset mapping relationship.

3. The method of claim 2, wherein a construction process of the preset mapping relationship comprises:
associating a constituent element of a character image with a corresponding rendering level, wherein the constituent element is configured for indicating an element that constitutes a rendering effect of the character image; and
adding a layer tag to an image element comprised in each constituent element, wherein the layer tag is configured for indicating the rendering level to which the constituent element corresponding to the image element belongs, and the image element is configured for indicating a characteristic of the constituent element to which the image element belongs in a specific dimension.

4. The method of claim 3, wherein for a newly added constituent element, the method further comprises:
determining whether the newly added constituent element can be associated with an existing rendering level in the mapping relationship;
if yes, adding a layer tag of the existing rendering level corresponding to the newly added constituent element to an image element comprised in the newly added constituent element; and
if no, creating a newly added layer for the newly added constituent element, and adding a layer tag corresponding to the newly added layer to the image element comprised in the newly added constituent element.

5. The method of claim 3, wherein the determining that the first image element belongs to the first rendering level and the second image element belongs to the second rendering level based on the preset mapping relationship comprises:
acquiring a first layer tag of the first image element and a second layer tag of the second image element from the mapping relationship, wherein the first layer tag is configured for indicating the first rendering level, and the second layer tag is configured for indicating the second rendering level; and
determining that the first image element belongs to the first rendering level based on the first layer tag, and determining that the second image element belongs to the second rendering level based on the second layer tag.

6. The method of claim 1, wherein the generating the rendered character image of the character to be rendered according to the first rendering result and the second rendering result comprises:
processing the first rendering result and the second rendering result according to a preset level rendering sequence to generate the rendered character image.

7. The method of claim 1, wherein the rendering effect information is further configured for indicating that a value of the first image element is a first value and a value of the second image element is a second value, and the rendering the first image element for the character to be rendered at the first rendering level to obtain a first rendering result, and rendering the second image element for the character to be rendered at the second rendering level to obtain the second rendering result comprises:
rendering, at the first rendering level, the first image element for the character to be rendered based on the first value to obtain the first rendering result, and rendering, at the second rendering level, the second image element for the character to be rendered based on the second value to obtain the second rendering result.

8. The method of claim 1, wherein the method further comprises:
adding an update tag to the first rendering level to which the first image element belongs in response to an update operation for a value of the first image element of the character to be rendered; and
updating the value of the first image element based on the update tag,
the rendering the first image element for the character to be rendered at the first rendering level to obtain the first rendering result comprises:
rendering, at the first rendering level, the first image element for the character to be rendered with the updated value of the first image element to obtain the first rendering result.

9. The method of claim 1, wherein the image elements indicated by the rendering effect information correspond to at least two of the following rendering levels: a canvas layer, a background layer, a text selection box layer, a shadow layer, an outline layer, an emoji layer, a fill layer, an inner shadow layer, a bloom layer, or a global blend layer.

10. The method of claim 1, wherein the image elements comprise at least one of a color or a size of a corresponding constituent element.

11. An electronic device, wherein the electronic device comprises: a processor and a memory;
the memory is configured to store instructions or a computer program; and
the processor is configured to execute the instructions or the computer program in the memory to cause the electronic device to perform a character rendering method, comprising:
acquiring rendering effect information of a character to be rendered in a character image rendering task in response to execution of the character image rendering task, wherein the rendering effect information is configured for indicating a first image element and a second image element;
rendering the first image element for the character to be rendered at a first rendering level to obtain a first rendering result, and rendering the second image element for the character to be rendered at a second rendering level to obtain a second rendering result; and
generating a rendered character image of the character to be rendered according to the first rendering result and the second rendering result.

12. The electronic device of claim 11, wherein the method further comprises:
determining that the first image element belongs to the first rendering level and the second image element belongs to the second rendering level based on a preset mapping relationship.

13. The electronic device of claim 12, wherein a construction process of the preset mapping relationship comprises:
associating a constituent element of a character image with a corresponding rendering level, wherein the constituent element is configured for indicating an element that constitutes a rendering effect of the character image; and
adding a layer tag to an image element comprised in each constituent element, wherein the layer tag is configured for indicating the rendering level to which the constituent element corresponding to the image element belongs, and the image element is configured for indicating a characteristic of the constituent element to which the image element belongs in a specific dimension.

14. The electronic device of claim 13, wherein for a newly added constituent element, the method further comprises:
determining whether the newly added constituent element can be associated with an existing rendering level in the mapping relationship;
if yes, adding a layer tag of the existing rendering level corresponding to the newly added constituent element to an image element comprised in the newly added constituent element; and
if no, creating a newly added layer for the newly added constituent element, and adding a layer tag corresponding to the newly added layer to the image element comprised in the newly added constituent element.

15. The electronic device of claim 13, wherein the determining that the first image element belongs to the first rendering level and the second image element belongs to the second rendering level based on the preset mapping relationship comprises:
acquiring a first layer tag of the first image element and a second layer tag of the second image element from the mapping relationship, wherein the first layer tag is configured for indicating the first rendering level, and the second layer tag is configured for indicating the second rendering level; and
determining that the first image element belongs to the first rendering level based on the first layer tag, and determining that the second image element belongs to the second rendering level based on the second layer tag.

16. A non-transitory computer-readable storage medium, wherein instructions are stored in the computer-readable storage medium, and the instructions, when run on a processor, cause the processor to perform a character rendering method, comprising:
acquiring rendering effect information of a character to be rendered in a character image rendering task in response to execution of the character image rendering task, wherein the rendering effect information is configured for indicating a first image element and a second image element;
rendering the first image element for the character to be rendered at a first rendering level to obtain a first rendering result, and rendering the second image element for the character to be rendered at a second rendering level to obtain a second rendering result; and
generating a rendered character image of the character to be rendered according to the first rendering result and the second rendering result.

17. The non-transitory computer-readable storage medium of claim 16, wherein the method further comprises:
determining that the first image element belongs to the first rendering level and the second image element belongs to the second rendering level based on a preset mapping relationship.

18. The non-transitory computer-readable storage medium of claim 17, wherein a construction process of the preset mapping relationship comprises:
associating a constituent element of a character image with a corresponding rendering level, wherein the constituent element is configured for indicating an element that constitutes a rendering effect of the character image; and
adding a layer tag to an image element comprised in each constituent element, wherein the layer tag is configured for indicating the rendering level to which the constituent element corresponding to the image element belongs, and the image element is configured for indicating a characteristic of the constituent element to which the image element belongs in a specific dimension.

19. The non-transitory computer-readable storage medium of claim 18, wherein for a newly added constituent element, the method further comprises:
determining whether the newly added constituent element can be associated with an existing rendering level in the mapping relationship;
if yes, adding a layer tag of the existing rendering level corresponding to the newly added constituent element to an image element comprised in the newly added constituent element; and
if no, creating a newly added layer for the newly added constituent element, and adding a layer tag corresponding to the newly added layer to the image element comprised in the newly added constituent element.

20. The non-transitory computer-readable storage medium of claim 18, wherein the determining that the first image element belongs to the first rendering level and the second image element belongs to the second rendering level based on the preset mapping relationship comprises:
acquiring a first layer tag of the first image element and a second layer tag of the second image element from the mapping relationship, wherein the first layer tag is configured for indicating the first rendering level, and the second layer tag is configured for indicating the second rendering level; and
determining that the first image element belongs to the first rendering level based on the first layer tag, and determining that the second image element belongs to the second rendering level based on the second layer tag.
